(19) United States
(12) Patent Application Publication
(10) Pub. No.: US 2012/0226773 A1
(43) Pub. Date: Sep. 6, 2012

(54) IMAGE READING APPARATUS, IMAGE READING METHOD, AND COMPUTER PROGRAM PRODUCT

(76) Inventor: Hiromi TSUDA, Kanagawa (JP)

(21) Appl. No.: 13/399,164

(22) Filed: Feb. 17, 2012

(30) Foreign Application Priority Data
Mar. 3, 2011 (JP) 2011-046537

(51) Int. Cl. G06F 15/16

(52) U.S. Cl. 709/217

(57) ABSTRACT

An image reading apparatus includes a specifying unit that specifies address information, which indicates a data storage location in a first server that is connected via a network; an image data delivering unit that delivers image data, which is obtained by reading an original image, to the data storage location indicated by the address information specified by the specifying unit; a generating unit that generates log data containing file path information, the file path information containing a file name of the image data and the address information that indicates the data storage location to which the image data is sent; and a log editing unit that adds the log data to a delivery log maintained in a second server connected via the network.

### CROSS-REFERENCE TO RELATED APPLICATIONS

The present application claims priority to and incorporates by reference the entire contents of Japanese Patent Application No. 2011-046537 filed in Japan on Mar. 3, 2011.

### BACKGROUND OF THE INVENTION

1. Field of the Invention

The present invention relates to an image reading apparatus, an image reading method, and a computer program product for controlling the image reading apparatus.

2. Description of the Related Art

Typically, some image reading apparatuses are known that deliver image data, which is obtained by reading an original image, to a specific computer over a network. Moreover, a technique is known in which, in the abovementioned type of image reading apparatuses, the address information (such as the file path) of the delivery destination of the image data is notified to the user. With the implementation of that technique, the manual operations that the user needs to perform for browsing the image data delivered thereto can be simplified. This enables achieving enhancement in the work efficiency.

For example, Japanese Patent Application Laid-open No. 2006-135496 discloses a technique in which, once a document (image data) has been delivered, the address information that enables accessing the delivered document is sent to the user in the form of a uniform resource locator (URL) string via an electronic mail. Thus, according to the technique disclosed in Japanese Patent Application Laid-open No. 2006-135496, the task of document browsing can be performed more efficiently after a document is delivered.

Thus, since the user is notified about the address information of a delivery destination of image data; even when a certain period of time elapses after the image reading apparatus has performed the image reading operation, the user is able to know without difficulty the address of the image data to be accessed.

However, when the address information of delivery destinations is notified via an electronic mail, only those specific individuals who have been listed as receivers in the electronic mail are notified about the address information. Hence, the notification lacks in providing a list as a delivery log. Moreover, for example, if the administrator wishes to check the overall delivery status of the image data and if electronic mails are used to notify the delivery information, then the administrator is forced to check, one by one, all the electronic mails that were sent following the respective deliveries. Such a task requires a lot of time and effort.

In the technique disclosed Japanese Patent Application Laid-open No. 2006-135496, since an electronic mail contains the URL of a delivery destination, the corresponding document can be directly accessed using the URL. Still, the problem that the notification lacks in providing a list as a delivery log remains unresolved.

Meanwhile, it is also possible to devise a method for checking the address information of delivery destinations from a delivery log that is recorded inside the image reading apparatus. However, in such a method, the address information specified in the delivery log is not in the format which would allow a direct access to the delivery destinations. Thus, the image data at the delivery destinations cannot be directly accessed just by referring to the delivery log.

Therefore, there is a need for an image reading apparatus and method capable of providing an easier access to a delivery destination of image data and presenting an easy-to-see list of the delivery destinations.

### SUMMARY OF THE INVENTION

According to an embodiment, there is provided an image reading apparatus that includes a specifying unit that specifies address information, which indicates a data storage location in a first server that is connected via a network; an image data delivering unit that delivers image data, which is obtained by reading an original image, to the data storage location indicated by the address information specified by the specifying unit; a generating unit that generates log data containing file path information, the file path information containing a file name of the image data and the address information that indicates the data storage location to which the image data is sent; and a log editing unit that adds the log data to a delivery log maintained in a second server connected via the network.

According to another embodiment, there is provided an image reading method that includes specifying address information, which indicates a data storage location in a first server that is connected via a network; delivering image data, which is obtained by reading an original image, to the data storage location indicated by the address information specified at the specifying; generating log data containing file path information, the file path information containing a file name of the image data and the address information that indicates the data storage location to which the image data is sent; and editing that includes adding the log data to a delivery log maintained in a second server connected via the network.

According to still another embodiment, there is provided a computer program product comprising a non-transitory computer-readable medium including programmed instructions. The instructions, when executed by a computer, cause the computer to execute specifying address information, which indicates a data storage location in a first server that is connected via a network; delivering image data, which is obtained by reading an original image, to the data storage location indicated by the address information specified at the specifying; generating log data containing file path information, the file path information containing a file name of the image data and the address information that indicates the data storage location to which the image data is sent; and editing that includes adding the log data to a delivery log maintained in a second server connected via the network.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an exemplary configuration of a system in which an image reading apparatus according to a first embodiment of the present invention can be installed;

FIG. 2 is an exemplary block diagram illustrating functions of the system illustrated in FIG. 1;

FIGS. 3A to 3c are schematic diagrams of exemplary displays on a display unit of the image reading apparatus according to the first embodiment;

FIG. 4 is a schematic diagram of an exemplary delivery log selection screen according to the first embodiment that enables selection of a delivery log to be browsed;

FIG. 5 is a schematic diagram of an exemplary delivery log screen according to the first embodiment;

FIG. 6 is a schematic diagram of an example of items constituting the delivery log according to the first embodiment;

FIG. 7 is a schematic diagram of exemplary files that are required for displaying the delivery log selection screen and the delivery log screen according to the first embodiment;

FIG. 8 is an exemplary flowchart for explaining a sequence of operations for outputting a delivery log according to the first embodiment; and

FIG. 9 is a block diagram of an exemplary configuration of a multifunction product according to a second embodiment of the present invention.

### DETAILED DESCRIPTION OF THE PREFERRED EMBODIMENTS

### First Embodiment

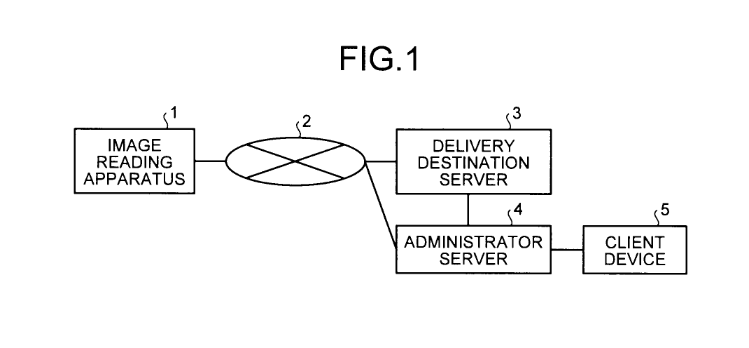

An image reading apparatus according to a first embodiment is described in detail below with reference to the accompanying drawings. FIG. 1 illustrates an exemplary configuration of a system in which an image reading apparatus 1 according to the first embodiment can be installed. The image reading apparatus 1 according to the first embodiment is connected to a network 2 such as a local area network (LAN). Besides, a delivery destination server 3 and an administrator server 4 are also connected to the network 2. The image reading apparatus 1, the delivery destination server 3, and the administrator server 4 can communicate with each other via the network 2. Meanwhile, a client device 5 such as a computer on the user side is also connected to the administrator server 4 in a mutually communicable manner.

In the example illustrated in FIG. 1, although the client device 5 is directly connected to the administrator server 4, it is also possible to connect the client device 5 to the network 2 so that the client device 5 and the administrator server 4 can communicate with each other via the network 2. Moreover, in the example illustrated in FIG. 1, although only the single image reading apparatus 1 is connected to the network 2, it is also possible to connect a plurality of the image reading apparatuses 1 to the network 2.

The image reading apparatus 1 includes an image reading unit that reads an original image and outputs image data; and includes a delivering unit that delivers the image data, which has been output to the image reading unit, to the network 2. The delivery destination server 3, the administrator server 4, and the client device 5 can have the configuration of a commonly-used computer that includes, for example, a central processing unit (CPU), a memory, an external memory device such as a hard disk drive (HDD), an input device such as a sort keyboard, and a display.

In this system, the image reading apparatus 1 delivers image data, which is obtained by, for example, reading an original image, to the delivery destination server 3 via the network 2. Then, the delivery destination server 3 stores the image data, which is received from the image reading apparatus 1, at a specified storage location.

Upon delivering the image data to the delivery destination server 3, the image reading apparatus 1 generates log data that contains information regarding the method of accessing the image data (hereinafter, “information regarding the method of accessing the image data” is referred to as “access information”) and adds the log data to a delivery log in which the delivery history of image data is recorded.

The administrator server 4 converts the delivery log into format that can be browsed from the client device 5. At that time, based on the access information, which is recorded in the delivery log, of all the image data that has been delivered to the delivery destination server 3; the administrator server 4 adds, to the access information, information that enables accessing the image data while the delivery log is being browsed from the client device 5.

With such a configuration, when a shared directory in the administrator server 4 is accessed from the client device 5, it becomes possible not only to browse the delivery log but also to access the image data, which is stored in the delivery destination server 3, directly from the delivery log that is being browsed.

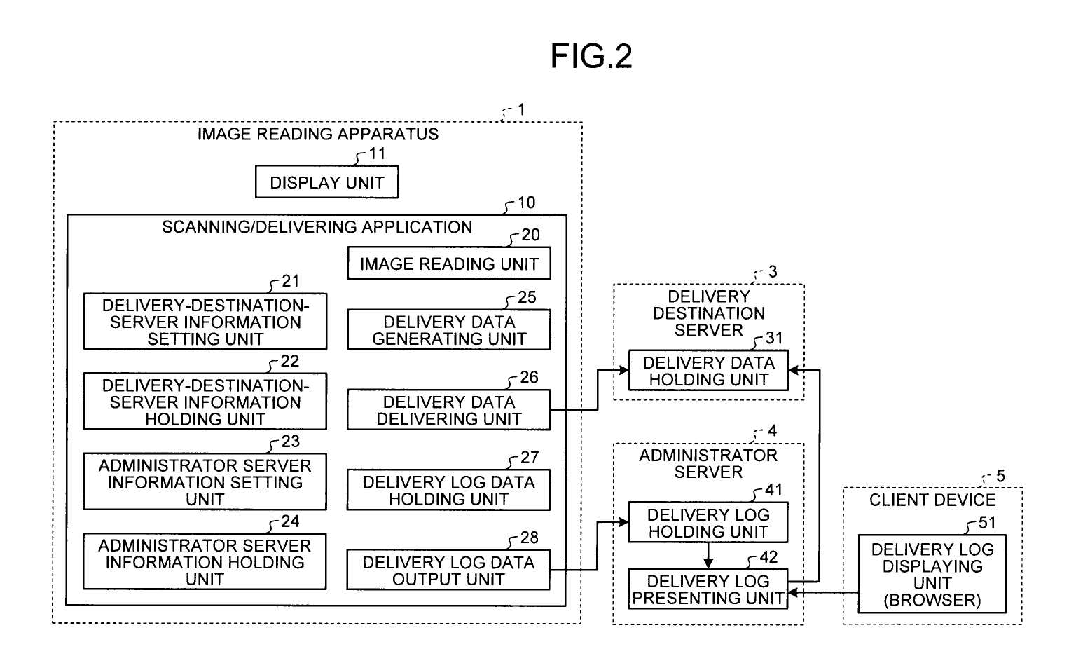

FIG. 2 is an exemplary block diagram illustrating functions of the system illustrated in FIG. 1. The image reading apparatus 1 includes a scanning/delivering application 10 and a display unit 11. The scanning/delivering application 10 is configured from, for example, modules of computer programs running in the CPU. The display unit 11 includes a display device such as a liquid crystal display (LCD) for displaying data based on display control signals that are generated in the CPU depending on the operations of the scanning/delivering application 10. The display unit 11 also has a handler disposed thereon for the purpose of receiving user operations. The handler can be a hardware switch, or can be a touch-sensitive panel that is integrally configured with the display device and that outputs a control signal according to the position of each touch.

The scanning/delivering application 10 includes an image reading unit 20, a delivery-destination-server information setting unit 21, a delivery-destination-server information holding unit 22, an administrator server information setting unit 23, an administrator server information holding unit 24, a delivery data generating unit 25, a delivery data delivering unit 26, a delivery log data holding unit 27, and a delivery log data output unit 28. The image reading unit 20 controls the operation of reading original images that is performed by an image reading mechanism implemented with hardware, and outputs image data after performing predetermined image processing on the image data that has been read.

The delivery-destination-server information setting unit 21 sets information related to the delivery destination server 3. The delivery-destination-server information holding unit 22 holds the information that has been set related to the delivery destination server 3. For example, the delivery-destination-server information setting unit 21 instructs the display unit 11 to display a delivery-destination-server information setting screen so as to prompt an input of information related to the delivery destination server 3. Then, the delivery-destination-server information holding unit 22 holds the information that is input from the delivery-destination-server information setting screen. For example, the information related to the delivery destination server 3 includes information regarding the storage location in the delivery destination server 3 for storing image data or includes authentication information necessary for allowing access to the storage location.

The administrator server information setting unit 23 sets information related to the administrator server 4. The administrator server information holding unit 24 holds the information that has been set related to the administrator server 4. For example, the administrator server information setting unit 23 instructs the display unit 11 to display an administrator server information setting screen so as to prompt an input of information related to the administrator server 4. Then, the administrator server information holding unit 24 holds the information that is input from the administrator server information setting screen. For example, the information related to the administrator server 4 includes information regarding the storage location in the administrator server 4 for storing a delivery log or includes authentication information necessary for allowing access to the storage location.

From the image data output by the image reading unit 20, the delivery data generating unit 25 generates delivery data that is to be delivered to the delivery destination server 3. For example, the delivery data generating unit 25 generates delivery data by assigning a file name to each set of image data as well appending predetermined attribute information to that image data.

The delivery data delivering unit 26 delivers the delivery data, which has been generated by the delivery data generating unit 25, to the delivery destination server 3. At that time, the delivery data delivering unit 26 refers to the information that is related to the delivery destination server 3 and that is held by the delivery-destination-server information holding unit 22, and accordingly delivers the delivery data to the storage location set in the delivery destination server 3. Upon delivering the delivery data, the delivery data delivering unit 26 generates a file path that would lead to the location of the delivery data in the delivery destination server 3.

The delivery log data holding unit 27 holds delivery log data that is generated by the delivery data delivering unit 26 at the time of delivering the delivery data and that includes the information related to the delivery of the delivery data. The delivery log data output unit 28 accesses a delivery log in the administrator server 4, and adds the delivery log data, which that has been held by the delivery log data holding unit 27, to the delivery log.

Meanwhile, the delivery destination server 3 includes a delivery data holding unit 31. The delivery data holding unit 31 holds the delivery data delivered by the delivery data delivering unit 26 of the image reading apparatus 1.

The administrator server 4 includes a delivery log holding unit 41 and a delivery log presenting unit 42. The delivery log holding unit 41 holds the delivery log output by the delivery log data output unit 28 of the image reading apparatus 1. Herein, the delivery log holding unit 41 is a shared directory created in a memory medium of the administrator server 4 and is, for example, allowed to be accessed from other devices.

The delivery log presenting unit 42 converts the delivery log, which is held by the delivery log holding unit 41, into a format that can be browsed from other computers; generates presentation information for presenting the delivery log to other computers; and stores the presentation information at a predetermined storage location in a memory medium. Moreover, based on the access information that is recorded in the delivery log and that corresponds to the delivery data delivered to the delivery destination server 3, the delivery log presenting unit 42 adds, to the access information within the presentation information, information (referred to as “link information”) that enables another computer to access the delivery data while the delivery log is being browsed from the computer.

The client device 5 includes a delivery log displaying unit 51, which accesses the presentation information generated by the administrator server 4 and displays a list as the delivery log. Moreover, by referring to the link information added to the access information within the presentation information, the delivery log displaying unit 51 can also access the delivery data holding unit 31 of the delivery destination server 3 and then obtain the delivery data specified in that access information. When the presentation information is specified in the hypertext markup language (HTML) format, a Web browser can serve as the delivery log displaying unit 51.

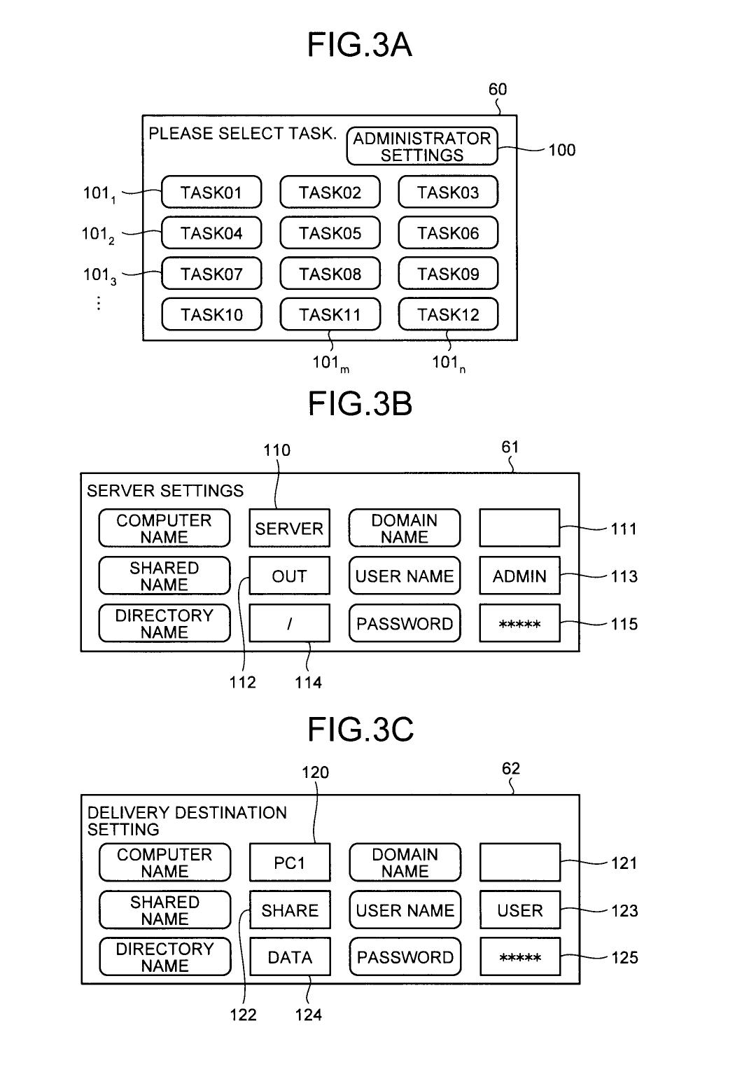

FIGS. 3A to 3C illustrate examples of displays on the display unit 11 of the image reading apparatus 1. FIG. 3A illustrates an example of a selection screen 60 that is displayed to enable selection between information regarding the administrator server 4 and information regarding the delivery destination server 3. In this example, on the selection screen 60 displayed on the display unit 11, there are arranged a plurality of buttons, namely, a button 100 and buttons 101₁, 101₂, . . . , 101ₘ, . . . , and 101ₙ. Among those buttons, the button 100 is operated to display a screen for setting information related to the administrator server 4. In contrast, each of the buttons 101₁, 101₂, . . . , 101ₘ, . . . , and 101ₙ is operated to display information related to the delivery destination server 3.

FIG. 3B illustrates an example of an administrator server information setting screen 61 that is used for setting information related to the administrator server 4. When the button 100 is operated, the administrator server information setting unit 23 displays the administrator server information setting screen 61. The administrator server information setting screen 61 has input units for inputting a computer name 110, a domain name 111, a shared name 112, a user name 113, a directory name 114, and a password 115 as the information related to the administrator server 4.

Once the information is input from each input unit followed by the operation of an OK button (not shown), the information input from the input units is finalized and is held in the administrator server information holding unit 24. Instead, if a cancel button (not shown) is operated, the operations performed with respect to the administrator server information setting screen 61 are cancelled and, for example, the display returns to the selection screen 60.

On the administrator server information setting screen 61, the computer name 110 represents the name given to the administrator server 4; the domain name 111 represents the identification information used in identifying the administrator server 4 in the network 2; and the shared name 112 represents the name given to a directory, which has been specified in the directory name 114 (described later), at the time of sharing the directory with other computers. Thus, a directory that is given a shared name and that is allowed to be shared is referred to as a shared directory.

Moreover, the user name 113 represents the identification information used when the image reading apparatus 1 accesses the shared directory. The user name 113 is used in combination with a password. Herein, as the user name 113, for example, a name “admin” is input as an indication that the directory specified in the directory name 114 (described below) can be accessed with administrator rights. The directory name 114 represents the name of a directory in which the delivery log is stored. Thus, the administrator server information setting screen 61 is used to set the information for enabling the image reading apparatus 1 to access the storage location of the delivery log in the administrator server 4.

FIG. 3C illustrates an example of a delivery-destination-server information setting screen 62, which is displayed by the delivery-destination-server information setting unit 21 in response to the operation of any one of the buttons 101₁, 101₂, . . . , 101ₘ, . . . , and 101ₙ.

Each of the buttons 101₁, 101₂, . . . , 101ₘ, . . . , and 101ₙ illustrated in FIG. 3A corresponds to a particular task and enables selection of a particular usage of the image data that has been obtained by reading an original image in the image reading unit 20. Herein, the usages of the image data can be, for example, “drawing”, “expense sheet”, “room information”, “bulletin report”, “contract agreement”, and “personal document”. Each of the buttons 101₁, 101₂, . . . , 101ₘ, . . . , and 101ₙ corresponds to one of those usages.

On the delivery-destination-server information setting screen 62; a computer name 120, a domain name 121, a shared name 122, a user name 123, a directory name 124, and a password 125 can be set as the information related to the delivery destination server 3.

Once the information is input from each input unit followed by the operation of an OK button (not shown), the information input in the input units is finalized and is held in the delivery-destination-server information holding unit 22 in a corresponding manner to the information regarding the tasks. Instead, if a cancel button (not shown) is operated, the operations performed with respect to the delivery-destination-server information setting screen 62 are cancelled and, for example, the display returns to the selection screen 60.

On the delivery-destination-server information setting screen 62, the computer name 120 represents the name given to the delivery destination server 3; the domain name 121 represents the identification information used in identifying the delivery destination server 3 in the network 2; and the shared name 122 represents the name given to a directory, which has been specified in the directory name 124 (described later), at the time of sharing that directory with other computers.

Moreover, the user name 123 represents the identification information used when the image reading apparatus 1 accesses the shared directory. The user name 123 is used in combination with the password 125. For example, when user authentication is required in the image reading apparatus 1, the user name 123 that is registered as the authentication information is input along with the password 125. In the example illustrated in FIG. 3C, a name “user” is input as the user name 123. When the user authentication need not be performed in the image reading apparatus 1, the user name 123 becomes null.

The directory name 124 represents the name of a directory in which the delivery data is stored. Thus, the delivery-destination-server information setting screen 62 is used to set the information for the purpose of delivering the delivery data from the image reading apparatus 1 to the storage location in the delivery destination server 3.

Meanwhile, in each of the buttons 101₁, 101₂, . . . , 101ₘ, . . . , and 101ₙ, it is possible to set different information of the delivery destination server 3. For example, in each of the buttons 101₁, 101₂, . . . , 101ₘ, . . . , and 101ₙ, a different directory name 124 can be set so that it becomes possible to change the storage location of the delivery data for every usage of the image data.

Meanwhile, in the input units present on the administrator server information setting screen 61 and present on the delivery-destination-server information setting screen 62, the user either can directly perform the input operation or can select from input values that are input in advance. Alternatively, each input value can also be set to a fixed value so as to prevent the user from making any changes.

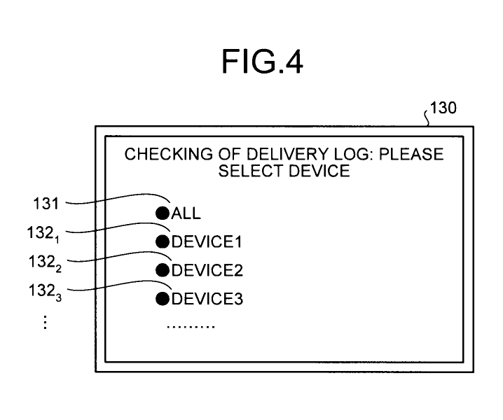

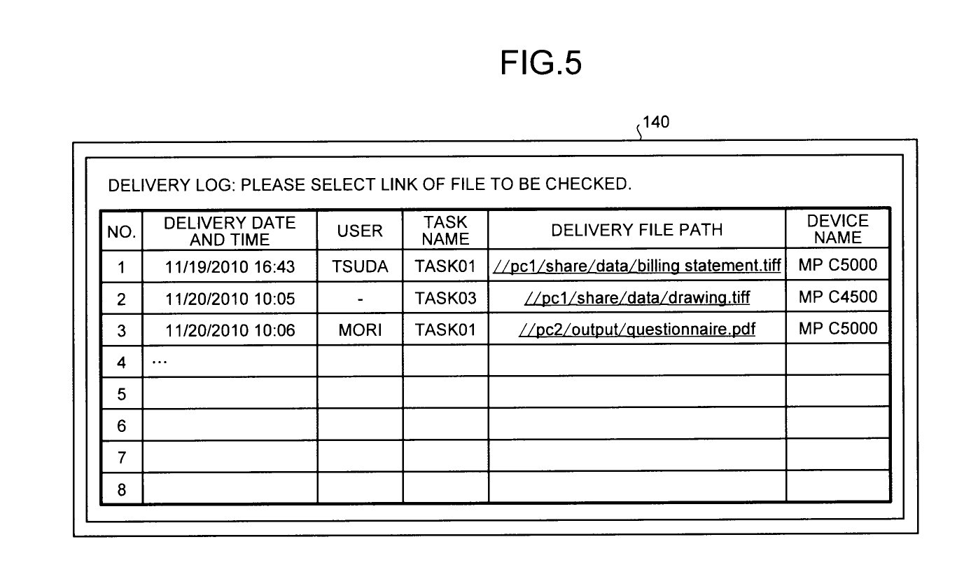

Explained below with reference to FIGS. 4 and 5 is an example of a display performed by the delivery log displaying unit 51 of the client device 5 according to the first embodiment. FIG. 4 illustrates an example of a delivery log selection screen 130 that enables selection of the delivery log to be browsed. On the delivery log selection screen 130 are displayed an item 131 as well as items 132₁, 132₂, 132₃, and so on. When selected, each of those items displays a corresponding delivery log screen.

In the example illustrated in FIG. 4, it is assumed that a plurality of image reading apparatus 1 is connected to the network 2. When the item 131 is selected, a delivery log display screen having the delivery logs of all the image reading apparatuses 1 is displayed. In contrast, when any one of the items 132₁, 132₂, 132₃, and so on are selected, only a single delivery log screen having the delivery log of the image reading apparatus 1 corresponding to the selected item is displayed.

FIG. 5 illustrates an example of a delivery log screen 140. Herein, it is assumed that the item 131 is selected from the delivery log selection screen 130 illustrated in FIG. 4. In this example, “No. (log number)”, “delivery date and time”, “user”, “task name”, “delivery file path”, and “device name” are displayed as display items for delivery logs. Herein, it is illustrated that each record contains all these display items. In the delivery log is recorded a delivery history of all delivery data delivered by the image reading apparatuses 1 connected to the network 2. As described later, a single set of delivery log data that is generated at the time of delivering some delivery data is added as a record to the delivery log in a sequential manner.

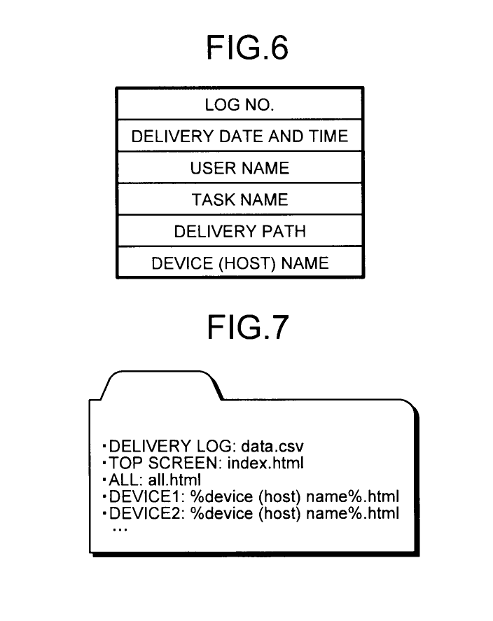

FIG. 6 illustrates an example of the items constituting the delivery log. Of those items, “log number (log No.)” represents the identification information used in identifying the delivery log data (records) included in the delivery log. As “log No.”, it is possible to use, for example, serial numbers. For example, the log number of a newly-added delivery log data is assigned with a number that is obtained by incrementing by one the latest log number that was recorded in the delivery log. Consider the case when a plurality of image reading apparatuses 1 is connected to the network 2. In that case, every time delivery data is delivered by one of the image reading apparatuses 1, the delivery log data is added in the delivery log. Thus, the delivery log can have the delivery log data corresponding to a plurality of image reading apparatuses 1.

The display item “delivery date and time” represents the date and time of delivery of delivery data. The display item “user name” is put to use when user authentication is required by the corresponding image reading apparatus 1. Moreover, in the display item “user name” is specified the name of the user who performed, for example, an operation of delivering the delivery data. In the display item “task name” is specified the name of the task that is set corresponding to the delivery data. In the display item “delivery path” is specified the file path of the delivery data. Herein, the file path includes a file name and the information that enables identification of the location of the file in the network 2. In the display item “device name” is specified the host name that is set in advance with respect to the corresponding image reading apparatus 1. The host name is uniquely set with respect to each image reading apparatus 1 connected at least to the network 2.

In each file path displayed in the display item “delivery file path” in FIG. 5, a link is set for the file specified in that file path. Thus, by specifying the link of a desired file using the client device 5, the user can directly access the desired file from the client device 5. Meanwhile, in the display illustrated in FIG. 5, by specifying an item name from the client device 5, the display of the records is sorted with the data of the specified item name serving as the sort key.

Meanwhile, although not illustrated, when any one of the items 132₁, 132₂, 132₃, and so on is selected from the delivery log selection screen 130; then, from among the records of the delivery log, the records of the device names other than the device name corresponding to the selected item are filtered so that the record of only the device name corresponding to the selected item is selectively displayed on the delivery log screen 140.

In the first embodiment, the delivery log selection screen 130 and the delivery log screen 140 are generated using HTML. FIG. 7 illustrates exemplary files that are required for displaying the delivery log selection screen 130 and the delivery log screen 140. In a file “data.csv”, the delivery log is stored. Herein, for example, the delivery log is assumed to be the data in the csv format in which data is separated by commas and records are separated by carriage returns.

A file “index.html” is the file for displaying the top screen, that is, the delivery log selection screen 130 illustrated in FIG. 4. A file “all.html” is displayed in response to the selection of the item 131 and is the file for displaying the delivery log including the delivery log data from all image reading apparatuses 1. Each of a plurality of files “% device (host) name %.html” is a file for selectively displaying the delivery log of one of the image reading apparatus 1, and has the device name of that image reading apparatus 1 in the file name. In the file “index.html” is specified the link information regarding the file “all.html”, the files “% device (host) name %.html”, and so on.

The file “all.html” and the files “% device (host) name %.html” serve as the files for displaying the file “data.csv” in the csv format. For example, the delivery log presenting unit 42 of the administrator server 4 analyzes the file “data.csv” and converts it into data that can be displayed using HTML. The analysis and conversion with respect to the file “data.csv” is performed in a dynamic manner.

In order to dynamically convert the data in the csv format into data displayable in HTML, it is possible to make use of the data binding technology provided by Microsoft Corporation (registered trademark). According to the data binding technique, the file name of the file in the csv format and the items of records are specified in the HTML file so that the data in the csv format can be read from an external file and each record can be displayed in a browser compatible to the data binding technique. Moreover, according to the data binging technique, it is also possible to embed the link information of other files in the items of records or to perform sorting with data of each item as the sort key.

However, alternatively, the abovementioned conversion can also be performed using a programming language such as JavaScript (registered trademark) that can run upon being embedded in HTML-format data. In that case, the data format of the delivery log is not limited to the csv format.

In this example, it is assumed that the files “index.html”, “all.html”, “% device (host) name %.html”, and “data.csv” are stored in the same directory. However, alternatively, the file “index.html” can be stored in a directory at a different layer than the directory for storing the files “all.html”, “% device (host) name %.html”, and “data.csv”.

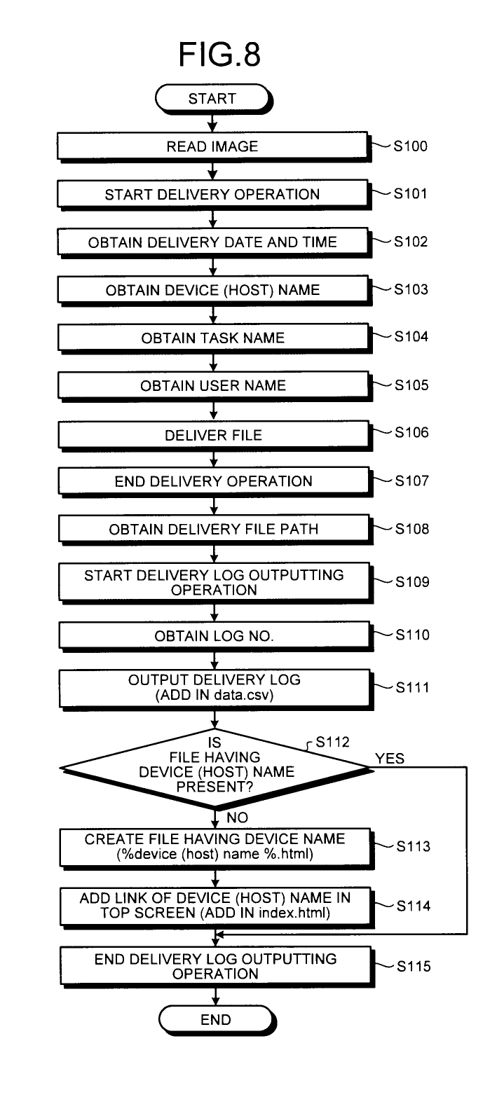

FIG. 8 is an exemplary flowchart for explaining a sequence of operations for outputting a delivery log according to the first embodiment. The operations explained with reference to the flowchart are performed in the image reading apparatus 1, and include delivering the delivery data to the delivery destination server 3 and updating the files “data.csv” and “index.html”.

Prior to performing the operations explained with reference to the flowchart, the information regarding the delivery destination server 3 and the information regarding the administrator server 4 is set as explained with reference to FIGS. 3A, 3B, and 3C; and the set information is held in the delivery-destination-server information holding unit 22 and the administrator server information holding unit 24.

Moreover, before execution of the operation of delivering image data in the image reading apparatus 1, a login operation can be performed to perform user authentication. For example, if a user operation specifies the image reading apparatus 1 to perform the operation of delivering image data, the image reading apparatus 1 instructs the display unit 11 to display an input screen to prompt the user to input a user name and a password, and then obtains the user name and the password input from the input screen. Then, the image reading apparatus 1 compares the obtained set of the user name and the password with the sets of user names and passwords recorded in advance in a user information holding unit (not illustrated). If any matching set is present, the image reading apparatus 1 allows the user to carry out the operation of delivering image data.

Firstly, the image reading unit 20 reads an original image and outputs image data (Step S100). The image data is temporarily stored in a memory medium such as an HDD installed in the image reading apparatus 1.

Then, the operation of delivering the image data, which is obtained at Step S100, starts (Step S101). The delivery data generating unit 25 obtains a variety of information for recording it in the delivery log data (Step S102 to Step S105). The obtained information is held in the delivery log data holding unit 27.

More particularly, the delivery data generating unit 25 obtains the delivery date and time of the image (Step S102) and obtains the device name (Step S103). The device name represents the name of the device that serves as the delivery host. Thus, the device name represents the name that is given in advance to the image reading apparatus 1.

Subsequently, the delivery data generating unit 25 obtains the task name (Step S104). For example, the delivery data generating unit 25 instructs the display unit 11 to display an input screen to prompt an input of the task name related to the image data that has been read, and obtains the task name input from the input screen. Alternatively, the configuration can be such that input of the task name is received before starting the image reading operation at Step S100. Meanwhile, the task name that is input needs to be associated with a delivery data storage location in the delivery destination server 3. For example, it is possible either to use the task name that is set from the delivery-destination-server information setting screen 62 illustrated in FIG. 3C or to select a task name from the task names stored in advance in the image reading apparatus 1.

Subsequently, the delivery data generating unit 25 obtains the user name (Step S105). For example, in an identical manner to Step S104, the delivery data generating unit 25 instructs the display unit 11 to display an input image to prompt an input of the user name, and obtains the user name from the input screen. Alternatively, the configuration can be such that input of the user name is received before starting the image reading operation at Step 5100. Still alternatively, the user name can also be selected from a plurality of user names registered in advance. Still alternatively, when the login operation is performed prior to starting the operation of delivering image data, the user name that is input during the login operation can also be used.

Once the delivery data generating unit 25 obtains a variety of information (Step S102 to Step S105) and stores it in the delivery log data holding unit 27, the image data obtained at Step S100 is delivered as delivery data to a specified delivery destination (Step S106).

As an example, as the information associated with the task name held by the delivery log data holding unit 27 at Step S104; the delivery data generating unit 25 obtains the computer name 120, the shared name 122, the user name 123, the directory name 124, and the password 125 from the delivery destination server 3. If a domain name is set in the network 2, then the delivery data generating unit 25 also obtains the domain name 121. Subsequently, from the information that has been obtained, the address information indicating the delivery data storage location in the delivery destination is generated along with login information that allows an access to that storage location.

Moreover, the delivery data generating unit 25 sets a file name to the file that contains the delivery data. For example, the delivery data generating unit 25 instructs the display unit 11 to display an input screen to prompt an input of a file name, obtains the file name input from the input screen, and sets that file name to the file containing the delivery data. Alternatively, the delivery data generating unit 25 can also generate a file name automatically based on information such as date information or time information that can be considered to be unique.

By referring to the address information, the login information, and the file name generated or obtained by the delivery data generating unit 25 in the manner described above; the delivery data delivering unit 26 delivers the delivery data to the delivery destination server 3. The delivery data is delivered as a file identified by the file name and is delivered to the storage location in the delivery destination server 3 as specified in the address information. Thus, that file gets stored at that storage location.

Once the delivery of the delivery data is completed (Step S107); in order to generate delivery log data related to the delivery of the delivery data, the delivery data delivering unit 26 generates a file path of the delivery data that has been delivered (hereinafter, referred to as “delivery file path”) (Step S108).

The delivery file path represents the information about the location of the file in an external memory device such as an HDD of a computer. In the first embodiment, the delivery file path is generated from the address information indicating the storage location of the delivery data in the network 2 and from the file name of the file containing the delivery data. Herein, the address information of the delivery data can be generated from the settings of the delivery destination server 3 illustrated in FIG. 3C.

As an example, assume that “20110131123056524.pdf” is the file name given to the delivery data. In that case, from the setting information of the delivery destination server 3 illustrated in FIG. 3C; the computer name 120 set to “pc1”, the shared name 122 set to “share”, and the directory name 124 set to “data” are combined in that order. Then, the address information is described as given below in description (1).

\\pc1\share\data (1)

To description (1), the file name “20110131123056524.pdf” is added so as to obtain description (2) given below that serves as the delivery file path for the delivery data having the file name “20110131123056524.pdf”.

\\pc1\share\data\20110131123056524.pdf (2)

Once the delivery data delivering unit 26 generates the delivery file path, the delivery log data output unit 28 starts the operation of outputting the delivery log (Step S109). During that operation, firstly, the delivery log data output unit 28 accesses the delivery log held in the delivery log holding unit 41 of the administrator server 4. The address information of the delivery log holding unit 41 is represented by the computer name 110, the domain name 111, the shared name 112, and the directory name 114 set in the administrator server information setting screen 61 illustrated in FIG. 3B.

For example, as explained with reference to description (1), from the setting information of the administrator server 4 illustrated in FIG. 3B, the computer name 110 set to “server”, the shared name 112 set to “out”, and the directory name 114 set to “/” are combined in that order to constitute the address information of the delivery log holding unit 41. Herein, the file name of the delivery log is assumed to be fixed to, for example, “data.csv”.

The delivery log data output unit 28 obtains the computer name 110, the domain name 111, the shared name 112, the user name 113, the directory name 114, and the password 115 that are set in the administrator server information setting screen 61 illustrated in FIG. 3B. Then, from the obtained information, the delivery log data output unit 28 generates the address information of the delivery log holding unit 41.

Moreover, as per the need, the delivery log data output unit 28 generates login information that allows an access to the storage location indicated by the address information.

According to the address information generated in the manner described above, the delivery log data output unit 28 accesses the file “data.csv” that is held in the delivery log holding unit 41 and that contains the delivery log. While accessing the delivery log holding unit 41, the login information is used when necessary.

The delivery log data output unit 28 obtains the log number of the latest delivery log data recorded in the delivery log (i.e., recorded in the file “data.csv”). Moreover, the delivery log data output unit 28 generates delivery log data that contains the delivery date and time, the device name, the task name, and the user name obtained by the delivery data generating unit 25 at Step S102 to Step S105 as well as contains the delivery file path generated by the delivery data delivering unit 26.

Meanwhile, information other than the abovementioned information can also be included in the delivery log data. At that time, by matching the items of information included in each set of delivery log data; the delivery log, which is obtained by sequentially adding the delivery log data, can be sorted with the information of each item as the sort key.

Subsequently, the delivery log data output unit 28 outputs the delivery log data that has been generated and adds it to the delivery log (adds it in the file “data.csv”) that is held in the delivery log holding unit 41 (Step S111). The log number corresponding to that delivery log data is obtained by incrementing by one the log number obtained at Step S110.

Then, the delivery log data output unit 28 checks whether a file “% device (host) name$ %.html” having the device name of the image reading apparatus 1 is present in a predetermined directory in the administrator server 4 (Step S112). If such a file is determined to be present, then the sequence of operations for outputting the delivery log is ended (Step S115).

On the other hand, if a file “% device (host) name$ %.html” having the device name of the image reading apparatus 1 is not present, the delivery log data output unit 28 creates a file “% device (host) name$ %.html”, which has the device name of the image reading apparatus 1, in a predetermined directory in the administrator server 4 (Step S113).

For example, it is possible that the delivery log data output unit 28 has the file “% device (host) name$ %.html” beforehand and copies that file in a predetermined directory in the administrator server 4. Alternatively, the delivery log data output unit 28 can create the file “% device (host) name$ %.html” by following a computer program to generate the code, which is to be stored in the file “% device (host) name$ %.html”, in a predetermined directory in the administrator server 4.

Subsequently, the delivery log data output unit 28 edits the file “index.html”, which is present in a predetermined directory in the administrator server 4 and which is meant for displaying the delivery log selection screen 130 that serves as the top screen, and adds a link for the file “% device (host) name$ %.html”, which has been created at Step S113, in the file “index.html” (Step S114). For example, it is possible that the delivery log data output unit 28 has the description of that link beforehand and inserts that description in the file “index.html”. Alternatively, the delivery log data output unit 28 can follow a computer program and output, to the file “index.html”, a code for implementing the link for the file “% device (host) name$ %.html”.

Once the operation at Step S114 is completed, the sequence of operations for outputting the delivery log is ended (Step S115).

With the sequence of operations described above, the delivery log file “data.csv” in the administrator server 4 gets updated as well as the HTML files “% device (host) name$ %.html” and “index.html” are created and updated when necessary. As a result, the delivery log selection screen 130 and the delivery log screen 140 explained with reference to FIGS. 4 and 5 can be displayed on the delivery log displaying unit 51 of the client device 5.

In this way, in the image reading apparatus 1 according to the first embodiment, at the time of delivering the delivery data, which is the image data read from an original image, to the delivery destination server 3; delivery log data containing the file path of the delivery data is generated. Then, while displaying a displaying log in which the delivery log data is sequentially added, a link for the delivery data is displayed based on the file path specified in the delivery log data. This enables the user to browse the history of delivery data that is displayed in the form of a list. Besides, by specifying a link displayed on the delivery log screen, the corresponding delivery data that is stored in the delivery destination server 3 can be directly accessed from the client device 5.

### Second Embodiment

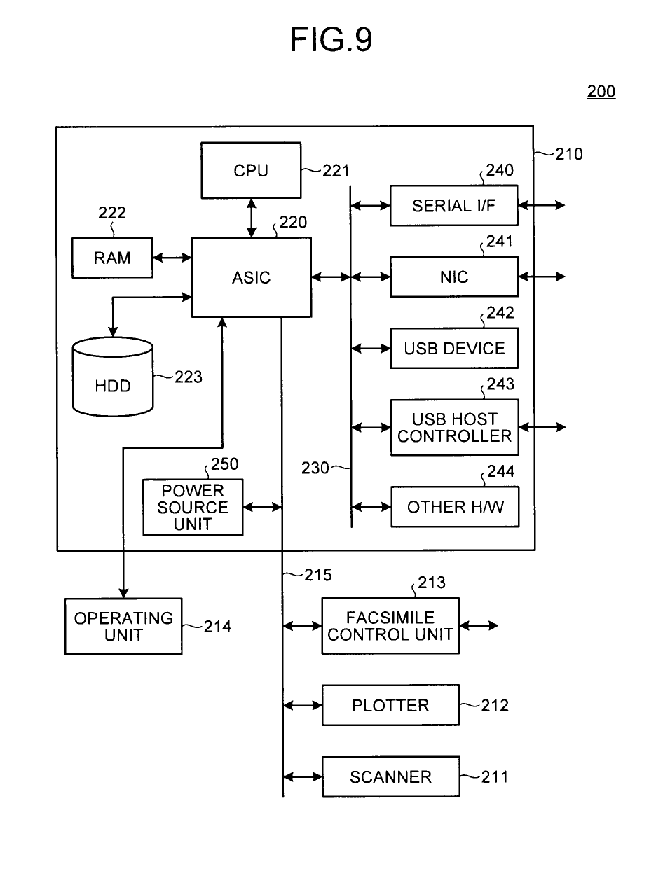

Explained below is a second embodiment of the present invention. In the second embodiment, the image reading apparatus 1 according to the first embodiment is implemented in a multifunction product 200 having a plurality of functions such as an image reading function, a printing function, a facsimileing function, and a copying function. FIG. 9 illustrates an exemplary configuration of the multifunction product 200 according to the second embodiment.

In a control unit 210 of the multifunction product 200; a CPU 221, a random access memory (RAM) 222, a hard disk drive (HDD) 223, and peripheral component interconnect (PCI) buses 215 and 230 are connected to an application specific integrated circuit (ASIC) 220.

To the PCI bus 230 are connected, for example, a serial interface (I/F) 240, a network interface card (NIC) 241, a universal serial bus (USB) device 242, a USB host controller 243, and other hardware (H/W) 244.

The ASIC 220 regulates the communication between the CPU 221, the RAM 222, the HDD 223, and the PCI bus 230. The HDD 223 is used to store, in advance, a variety of data or computer programs that are run by the CPU 221. Thus, the CPU 221 follows instructions that are specified in the computer programs stored in the HDD 223, makes use of the RAM 222 as a work memory, and controls the operations of the multifunction product 200 in entirety. At that time, intermediate data that is generated while running the computer programs can be temporarily stored in the HDD 223. Moreover, the HDD 223 is also used to store image data that is received via the PCI bus 215 (described later). The CPU 221 receives, via the ASIC 220, control signals in response to user operations performed from an operating unit 214. That enables controlling the multifunction product 200 according to the user operations.

The scanning/delivering application 10 illustrated in FIG. 2 is implemented as a computer program run by the CPU 221. The constituent elements of the scanning/delivering application 10 (i.e., the image reading unit 20, the delivery-destination-server information setting unit 21, the delivery-destination-server information holding unit 22, the administrator server information setting unit 23, the administrator server information holding unit 24, the delivery data generating unit 25, the delivery data delivering unit 26, the delivery log data holding unit 27, and the delivery log data output unit 28) are implemented as, for example, modules of that computer program. Moreover, the delivery-destination-server information holding unit 22, the administrator server information holding unit 24, and the delivery log data holding unit 27 hold the respective information in, for example, the HDD 223 or the RAM 222.

The serial I/F 240 serves as an interface such as RS-232C used for serial communication. The NIC 241 controls the communication with the Internet or a LAN. The USB device 242 is embedded in the image reading apparatus 1 and serves as a fixed USB device. The USB host controller 243 administers the USB bus and can have a USB device connected thereto as an external device.

To the PCI bus 215 are connected a scanner 211, a plotter 212, and a facsimile control unit 213. The scanner 211 includes an image reading mechanism that is controlled by the image reading unit 20 illustrated in FIG. 2 and that reads an original image and outputs it as image data. Then, the output image data is sent to the CPU 221 via the PCI bus 215 and the ASIC 220, and is stored in the HDD 223. The plotter 212 receives, for example, the image data from the HDD 223 via the ASIC 220 and the PCI bus 215, and performs printing on paper sheets based on the image data. The facsimile control unit 213 is connected, for example, to a public telephone line and sends the original image that has been read by the scanner 211 to a specified destination.

Meanwhile, to the PCI bus 215 is also connected a power source unit 250, which supplies power to the constituent elements of the multifunction product 200 under the control of the CPU 221.

Meanwhile, a control program executed in the multifunction product 200 according to the second embodiment is stored in advance in a read only memory (ROM) or the like (not illustrated).

Alternatively, the control program executed in the image reading apparatus 1 according to the first embodiment (or in the multifunction product 200 according to the second embodiment) can be provided in the form of an installable or executable file on a computer-readable recording medium such as a compact disk (CD), a flexible disk (FD), or a digital versatile disk (DVD).

Still alternatively, the control program executed in the image reading apparatus 1 according to the first embodiment (or in the multifunction product 200 according to the second embodiment) can be saved as a downloadable file on a computer connected to a network such as the Internet or can be made available for distribution through the network. Still alternatively, the control program executed in the image reading apparatus 1 according to the first embodiment (or in the multifunction product 200 according to the second embodiment) can be distributed over a network such as the Internet.

Herein, the control program executed in the multifunction product 200 according to the second embodiment contains modules for implementing the functions of the abovementioned constituent elements (the image reading unit 20, the delivery-destination-server information setting unit 21, the delivery-destination-server information holding unit 22, the administrator server information setting unit 23, the administrator server information holding unit 24, the delivery data generating unit 25, the delivery data delivering unit 26, the delivery log data holding unit 27, and the delivery log data output unit 28). Regarding the actual hardware, the CPU 221 retrieves the control program from, for example, a ROM or the HDD 223 and runs it so that the control program is loaded in a main memory device (for example, the RAM 222). As a result, the image reading unit 20, the delivery-destination-server information setting unit 21, the delivery-destination-server information holding unit 22, the administrator server information setting unit 23, the administrator server information holding unit 24, the delivery data generating unit 25, the delivery data delivering unit 26, the delivery log data holding unit 27, and the delivery log data output unit 28 are implemented in the main memory device.

According to the embodiments described above, it becomes possible to provide an easier access to a delivery destination of image data and to present an easy-to-see list of the delivery destinations.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image reading apparatus comprising:
a specifying unit that specifies address information, which indicates a data storage location in a first server that is connected via a network;
an image data delivering unit that delivers image data, which is obtained by reading an original image, to the data storage location indicated by the address information specified by the specifying unit;
a generating unit that generates log data containing file path information, the file path information containing a file name of the image data and the address information that indicates the data storage location to which the image data is sent; and
a log editing unit that adds the log data to a delivery log maintained in a second server connected via the network.

2. The image reading apparatus according to claim 1, wherein
the generating unit generates the log data further containing deliver date-time information indicating the date and time of delivery to the first server of the image data that is described in the log data, user information indicating a user who delivered the image data to the first server, usage information indicating a usage of the image data, and device identification information used in identification of the image reading apparatus.

3. The image reading apparatus according to claim 2, wherein
the generating unit generates the log data in such a way that the delivery log is sortable in the second server with each set of information contained in the log data as a sort key.

4. The image reading apparatus according to claim 1, wherein
the log editing unit adds the log data to the delivery log maintained in a shared folder that is created in the second server and that is kept accessible from another computer via the network.

5. The image reading apparatus according to claim 1, wherein
the log editing unit adds the log data to the delivery log that is converted into a format which can be browsed from a computer connected to the second server via the network.

6. An image reading method comprising:
specifying address information, which indicates a data storage location in a first server that is connected via a network;
delivering image data, which is obtained by reading an original image, to the data storage location indicated by the address information specified at the specifying;
generating log data containing file path information, the file path information containing a file name of the image data and the address information that indicates the data storage location to which the image data is sent; and
editing that includes adding the log data to a delivery log maintained in a second server connected via the network.

7. The image reading method according to claim 6, wherein
the generating includes generating the log data further containing deliver date-time information indicating the date and time of delivery to the first server of the image data that is described in the log data, user information indicating a user who delivered the image data to the first server, usage information indicating a usage of the image data, and device identification information used in identification of the image reading apparatus.

8. The image reading method according to claim 7, wherein
the generating includes generating the log data in such a way that the delivery log is sortable in the second server with each set of information contained in the log data as a sort key.

9. The image reading method according to claim 6, wherein
the editing includes adding the log data to the delivery log maintained in a shared folder that is created in the second server and that is kept accessible from another computer via the network.

10. The image reading method according to claim 6, wherein
the editing includes adding the log data to the delivery log that is converted into a format which can be browsed from a computer connected to the second server via the network.

11. A computer program product comprising a non-transitory computer-readable medium including programmed instructions, wherein the instructions, when executed by a computer, cause the computer to execute:
specifying address information, which indicates a data storage location in a first server that is connected via a network;
delivering image data, which is obtained by reading an original image, to the data storage location indicated by the address information specified at the specifying;
generating log data containing file path information, the file path information containing a file name of the image data and the address information that indicates the data storage location to which the image data is sent; and
editing that includes adding the log data to a delivery log maintained in a second server connected via the network.

12. The computer program product according to claim 11, wherein
the generating includes generating the log data further containing deliver date-time information indicating the date and time of delivery to the first server of the image data that is described in the log data, user information indicating a user who delivered the image data to the first server, usage information indicating a usage of the image data, and device identification information used in identification of the image reading apparatus.

13. The computer program product according to claim 12, wherein
the generating includes generating the log data in such a way that the delivery log is sortable in the second server with each set of information contained in the log data as a sort key.

14. The computer program product according to claim 11, wherein
the editing includes adding the log data to the delivery log maintained in a shared folder that is created in the second server and that is kept accessible from another computer via the network.

15. The computer program product according to claim 11, wherein
the editing includes adding the log data to the delivery log that is converted into a format which can be browsed from a computer connected to the second server via the network.
